(19) United States
(12) Patent Application Publication
(10) Pub. No.: US 2023/0334515 A1
(43) Pub. Date: Oct. 19, 2023

(54) SALES ASSISTANCE SYSTEM, SALES ASSISTANCE METHOD, AND PROGRAM RECORDING MEDIUM

(71) Applicant: NEC Corporation, Minato-ku, Tokyo (JP)

(72) Inventor: Ryosuke TOGAWA, Tokyo (JP)

(21) Appl. No.: 17/908,379

(22) PCT Filed: Mar. 27, 2020
(86) PCT No.: PCT/JP2020/013918

§ 371 Date: Aug. 31, 2022

(51) Int. Cl. G06Q 30/0202

(52) U.S. Cl. CPC G06Q 30/0202

(57) ABSTRACT

A sales assistance system comprises an acquisition unit and a prediction unit. The acquisition unit is configured to acquire attribute data on each of target customers as candidates for sales targets, and time-series data on actions included in sales activities that have been directed to a plurality of target customers until a predetermined time point. The prediction unit is configured to use a prediction model and the attribute data on the plurality of target customers and the time-series data acquired from the acquisition unit, and predicts recommended products for the target customers, and customers who are likely to purchase the recommended products among the target customers. The prediction model is generated based on the attribute data on each of a plurality of existing customers, time-series data on a plurality of actions included in sales activities, and product data about purchased products through the sales activities.

### TECHNICAL FIELD

The present invention relates to a technique for predicting customers who are likely to place orders, and particularly a technique for predicting customers who are likely to place orders based on actions in early stage of sales activities.

### BACKGROUND ART

Sales assistance systems that assist sales activities have been widely used. Many of sales assistance systems have a customer management function. However, it has been often determined, based on the experience of a sales representative, what product to focus on in sales activities for which customer among a new customer group to which actions in an early stage of sales activities are directed, such as holding a seminar as a part of the sales activities. Therefore, it is desirable to be able to predict customers who are likely to place orders among new customers and products that are likely to be ordered, and a technique for predicting customers who are likely to place orders and products that are likely to be ordered has been developed. As such a technique for predicting customers who are likely to place orders and products that are likely to be ordered, for example, such a technique as in PTL 1 is disclosed.

PTL 1 relates to a sales assistance system that predicts a new prospective customer. The sales assistance system of PTL 1 predicts a new transaction candidate with a customer based on statistical data, data such as previous purchase records of customers, and lifestyle data.

### CITATION LIST

### Patent Literature

[PTL 1] JP 2017-91503 A

### SUMMARY OF INVENTION

### Technical Problem

However, the technique of PTL 1 is not sufficient for the following reason. The sales assistance system of PTL 1 predicts a new transaction candidate based on data such as previous purchase records of customers. However, it is not possible to predict customers who are likely to place orders and products that are likely to be ordered, in consideration of actions already performed as sales activities.

In order to solve the above problem, an object of the present invention is to provide a sales assistance system, a sales assistance method, and a program recording medium capable of predicting customers who are likely to place orders among customers to which actions of sales activities are directed and products that are likely to be ordered.

### Solution to Problem

In order to solve the above problem, a sales assistance system of the present invention includes an acquisition unit and a prediction unit. The acquisition unit acquires attribute data on each of a plurality of target customers as candidates for sales targets, and sales process time-series data on time series of actions included in sales activities that have been directed to each of the plurality of target customers until a predetermined time point. The prediction unit uses a prediction model and the attribute data on the plurality of target customers and the sales process time-series data acquired by the acquisition unit, and predicts recommended products for the plurality of target customers, and customers who are likely to purchase the recommended products among the plurality of target customers. The prediction model is generated based on the attribute data on each of a plurality of existing customers in previous sales records before the predetermined time point, the sales process time-series data showing the time-series order of a plurality of actions included in sales activities directed to the plurality of existing customers, and product data about products purchased by the plurality of existing customers through the sales activities.

A sales assistance method of the present invention acquires attribute data on each of a plurality of target customers as candidates for sales targets, and sales process time-series data on time series of actions included in sales activities that have been directed to each of the plurality of target customers until a predetermined time point. The sales assistance method of the present invention uses a prediction model and the attribute data on the plurality of target customers and the sales process time-series data acquired, and predicts recommended products for the plurality of target customers, and customers who are likely to purchase the recommended products among the plurality of target customers. The prediction model is generated based on the attribute data on each of a plurality of existing customers in previous sales records before the predetermined time point, the sales process time-series data showing the time-series order of a plurality of actions included in sales activities directed to the plurality of existing customers, and product data about products purchased by the plurality of existing customers through the sales activities.

A program recording medium of the present invention records a sales assistance program. The sales assistance program makes a computer execute a process for acquiring attribute data on a plurality of target customers as candidates for sales targets, and sales process time-series data on time series of actions included in sales activities that have been directed to each of the plurality of target customers until a predetermined time point. The sales assistance program makes a computer execute a process for using a prediction model and the attribute data on the plurality of target customers and the sales process time-series data acquired, and predicting recommended products for the plurality of target customers, and customers who are likely to purchase the recommended products among the plurality of target customers. The prediction model is generated based on the attribute data on each of a plurality of existing customers in previous sales records before the predetermined time point, the sales process time-series data showing the time-series order of a plurality of actions included in sales activities directed to the plurality of existing customers, and product data about products purchased by the plurality of existing customers through the sales activities.

### Advantageous Effects of Invention

The sales assistance system and the like of the present invention can predict a customer who is likely to place an order among customers to which sales activities are directed and a product that is likely to be ordered. As a result, it is possible to assist the sales activities such as improving the success probability of receiving an order and the efficiency of the sales activities.

### BRIEF DESCRIPTION OF DRAWINGS

FIG. 1 is a diagram illustrating a configuration of a sales assistance system according to a first example embodiment of the present invention.

FIG. 2 is a diagram illustrating a configuration of a prediction model generation device according to the first example embodiment of the present invention.

FIG. 3 is a diagram schematically illustrating an example of a graph according to the first example embodiment of the present invention.

FIG. 4 is a diagram illustrating a configuration of a prediction device according to the first example embodiment of the present invention.

FIG. 5 is a diagram illustrating an operation flow of the prediction model generation device according to the first example embodiment of the present invention.

FIG. 6 is a diagram illustrating an example of input data according to the first example embodiment of the present invention.

FIG. 7 is a diagram illustrating an example of input data according to the first example embodiment of the present invention.

FIG. 8 is a diagram illustrating an example of input data according to the first example embodiment of the present invention.

FIG. 9 is a diagram illustrating an operation flow of the prediction device according to the first example embodiment of the present invention.

FIG. 10 is a diagram illustrating an example of prediction results according to the first example embodiment of the present invention.

FIG. 11 is a diagram illustrating an example of prediction results according to the first example embodiment of the present invention.

FIG. 12 is a diagram illustrating a configuration of a sales assistance system according to a second example embodiment of the present invention.

FIG. 13 is a diagram illustrating an operation flow of the sales assistance system according to the second example embodiment of the present invention.

FIG. 14 is a diagram illustrating an example of another configuration of the present invention.

### EXAMPLE EMBODIMENT

### First Example Embodiment

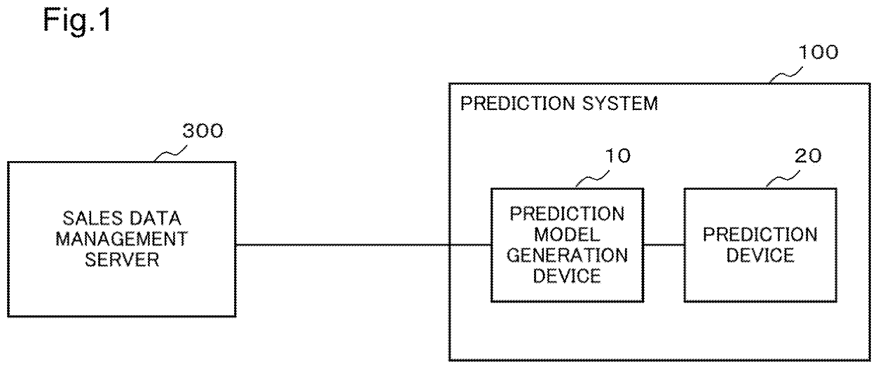

A first example embodiment of the present invention will be described in detail with reference to the drawings. FIG. 1 is a diagram illustrating an outline of a configuration of a sales assistance system of the present example embodiment. The sales assistance system of the present example embodiment includes a prediction system 100 and a sales data management server 300. The prediction system 100 and the sales data management server 300 are connected to each other via a network.

The sales assistance system of the present example embodiment is a system that predicts new customers who are likely to place orders and products that are likely to be ordered based on a prediction model generated by using attribute data of customers, activity histories of sales activities, and attribute data of products to be sold as inputs. A new customer refers to a customer who has a record of participation in a seminar or the like, but has no purchase record for a product to be sold and refers to a customer included in a customer group having no transaction record. In an early stage of sales activities, activities in a period in which specific sales activities for receiving orders are not performed for each customer are also referred to as marketing.

The prediction system 100 includes a prediction model generation device 10 and a prediction device 20. The prediction model generation device 10 and the prediction device 20 are connected via a network. Furthermore, the prediction model generation device 10 and the prediction device 20 may be formed as an integrated device. The functions of the units constituting the prediction model generation device 10 and the prediction device 20 may be achieved by different devices.

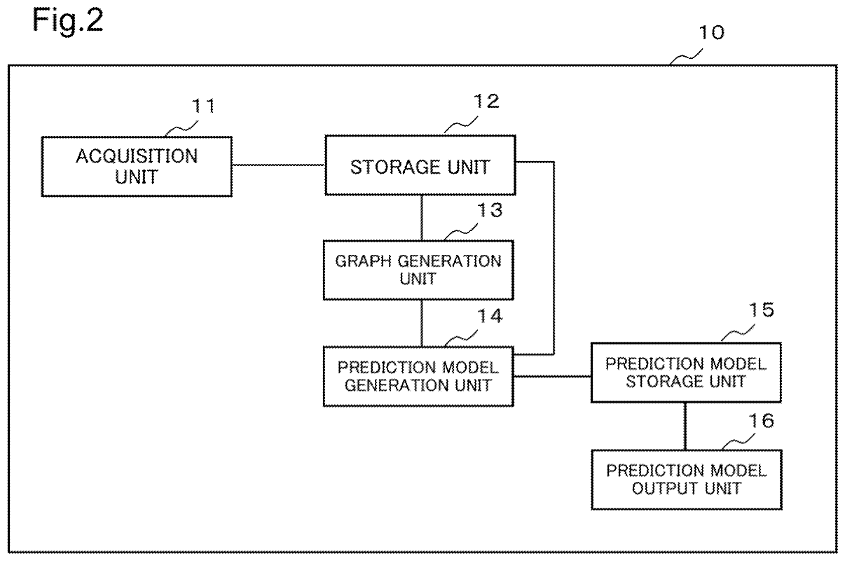

A configuration of the prediction model generation device 10 will be described. FIG. 2 is a diagram illustrating a configuration of the prediction model generation device 10. The prediction model generation device 10 includes an acquisition unit 11, a storage unit 12, a graph generation unit 13, a prediction model generation unit 14, a prediction model storage unit 15, and a prediction model output unit 16. The prediction model generation device 10 is a device that generates a prediction model to be used when predicting customers who are likely to place orders and products that are likely to be ordered based on an attribute of each of a plurality of customers (also referred to as existing customers) for which sales were made in the past, that is, sales records were made, an activity history of a sales activity for each of the existing customers, and an attribute of a product to be sold. Hereinafter, among a plurality of new customers (target customers) as candidates for sales targets at a predetermined time point, customers who are likely to place orders by prediction using a prediction model are also referred to as remarkable customers. Products that are predicted to be likely to be ordered by prediction using a prediction model are also referred to as recommended products in the sense that the products are recommended to the remarkable customers who are predicted to be likely to place orders. The products may include a service. The sales assistance system according to the present example embodiment can also predict customers who are unlikely to place orders and products that are unlikely to be ordered, instead of customers who are likely to place orders and products that are likely to be ordered.

The acquisition unit 11 acquires data used for generating a prediction model. The acquisition unit 11 acquires, as data used for generating a prediction model, identification information of each of a plurality of customers (existing customers) who have been targets of sales activities in the past, that is, have sales records in the past, attribute data of each of the customers (existing customers), attribute data of products to be sold, and data on success or failure of receiving an order.

The acquisition unit 11 acquires, for example, data of a company name or a name of a customer as identification information of the customer (existing customer), and acquires data of an industry type of the customer as attribute data of the customer. The identification information of the customer may be any information that can identify an organization or an individual, such as a company code, a membership number, or an identifier (ID) assigned to each customer. The acquisition unit 11 acquires, for example, data of a product type as attribute data of a product to be a target of a sales activity.

The acquisition unit 11 acquires, from the sales data management server 300, time-series data of an activity history for each case from a first action for each customer (existing customer) to confirmation of a result of success or failure of receiving an order regarding past sales activities. The data of the activity history includes information on actions performed in a sales activity for each case for each existing customer and on date and time when each action is executed. Therefore, from the data of the activity history, the information on the action performed in the sales activity for each existing customer and on the order of the time series of each action can be acquired. The data of the activity history, that is, the information indicating the action of the sales activity performed on the existing customers and indicating the order of the time series of each action is also referred to as sales process time-series data.

The action is an individual sales action performed by a sales representative for customers. For example, the action includes, but are not limited to, holding a seminar for a customer, making a phone call to a customer, transmitting a mail magazine to a customer, interviewing a customer, visiting a customer, discussing with a customer, negotiating with a customer and conducting sales (including price negotiations and product proposals), demonstrating a product or a system for a customer, invitation to an exhibition, visiting a factory, and having a social gathering with a customer, and include all behaviors performed as part of the general sales activities.

The storage unit 12 stores each piece of data input from the acquisition unit 11.

The graph generation unit 13 generates, as graph structure data, a graph from the sales process time-series data. The graph structure data generated from the sales process time-series data includes a node indicating each action in the sales activity for the existing customer and an edge indicating the order of each action by connecting two consecutive actions. The graph structure data indicates the time-series order of each action in a sales activity. Therefore, the graph structure data indicates the sales process. The action of the activity history of the sales activity may include an action in a marketing stage where the sales activity is not started, such as sales of a specific product.

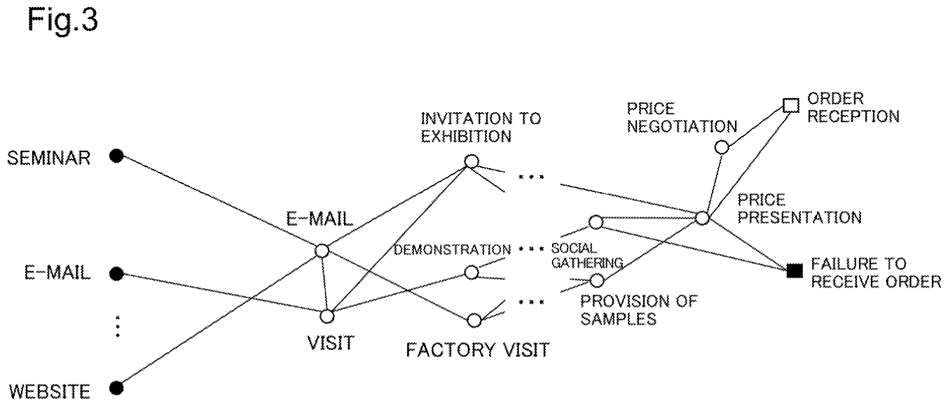

FIG. 3 schematically illustrates an example of a graph generated by the graph generation unit 13. FIG. 3 illustrates as one graph a graph generated from activity histories of a plurality of cases. White circles in FIG. 3 indicate actions in a sales process set as a node. Black circles in FIG. 3 indicate the first action for each case, that is, the action when contacting with a customer for the first time in the sales activity of the target case. In the sales activity of the target case, the action at the first contact with a customer is referred to as an entry point.

The prediction model generation unit 14 uses, as inputs, graph structure data based on an activity history of a sales activity, attribute data of a customer (existing customer), and attribute data of a product to be sold, and generates a prediction model for predicting customers who are likely to place orders and products that are likely to be ordered based on a label indicating success or failure of receiving an order. For example, the prediction model generation unit 14 generates a prediction model by machine learning using, as learning data, graph structure data generated from an activity history, attribute data of a customer, and attribute data of a product, and using, as a label, success or failure of receiving an order as a result of a sales activity. The prediction model generation unit 14 generates a prediction model by calculating a feature amount of a graph by machine learning using a neural network (NN). The prediction model generation unit 14 may generate a prediction model by performing machine learning using attribute data of a product purchased by a customer as a label instead of success or failure of receiving an order. A prediction model may be generated using any machine learning method such as supervised learning, unsupervised learning, semi-supervised learning, or reinforcement learning.

Alternatively, the prediction model generation unit 14 generates a prediction model by calculating a feature amount of a graph by, for example, the STAR method. The STAR method generates a prediction model by calculating a feature amount of a graph with graph structure data used as an input at a plurality of time points. The STAR method can identify important nodes on two axes of time and space among the nodes constituting the graph. Details of the STAR method are described in Dongkuan Xu et al., “Spatio-Temporal Attentive RNN for Node Classification in Temporal Attributed Graphs”, Proceedings of the Twenty-Eighth International Joint Conference on Artificial Intelligence (IJCAI-19), [searched on Feb. 27, 2020] Internet <URL: https://www.ijcai.org/Proceedings/2019/0548.pdf>.

The prediction model generation unit 14 may generate a prediction model by calculating a feature amount of a graph by the TGNet method.

The TGNet method performs machine learning with dynamic data, static data, and label data used as inputs, and generates a learned model. Details of the TGNet method are described in Qi Song, et al., “TGNet: Learning to Rank Nodes in Temporal Graphs”, Proceedings of the 27th ACM International Conference on Information and Knowledge Management, pp. 97-106.

The prediction model generation unit 14 may generate a prediction model by, for example, extracting a feature amount using a method for extracting a feature amount such as the Netwalk method and by combining a method for analyzing a feature amount such as the InerHAT method. Details of the Netwalk method are described in Wenchow Yu, et al., “NetWalk: A Flexible Deep Embedding Approach for Anomaly Detection in Dynamic Networks”, KDD 2018, pp. 2672-2681. Details of the InerHAT method are described in Zeyu Li, et al., “Interpretable Click-Through Rate Prediction through Hierarchical Attention”, WSDM 2020: The Thirteenth ACM International Conference on Web Search and Data Mining. Instead of the InerHAT method, a prediction technique such as the Gradient Boosting method may be used. The prediction model generation unit 14 may generate a prediction model using another method such as analyzing graph data and extracting a feature pattern.

The prediction model storage unit 15 stores a prediction model generated by the prediction model generation unit 14.

The prediction model output unit 16 outputs the prediction model stored in the prediction model storage unit 15 to the prediction device 20.

Each processing in the acquisition unit 11, the storage unit 12, the graph generation unit 13, the prediction model generation unit 14, and the prediction model output unit 16 is performed by executing a computer program on a central processing unit (CPU). A graphics processing unit (GPU) may be combined with the CPU.

The storage unit 12 and the prediction model storage unit 15 are configured using, for example, a hard disk drive. The storage unit 12 and the prediction model storage unit 15 may be configured with a nonvolatile semiconductor storage device or a combination of a plurality of types of storage devices.

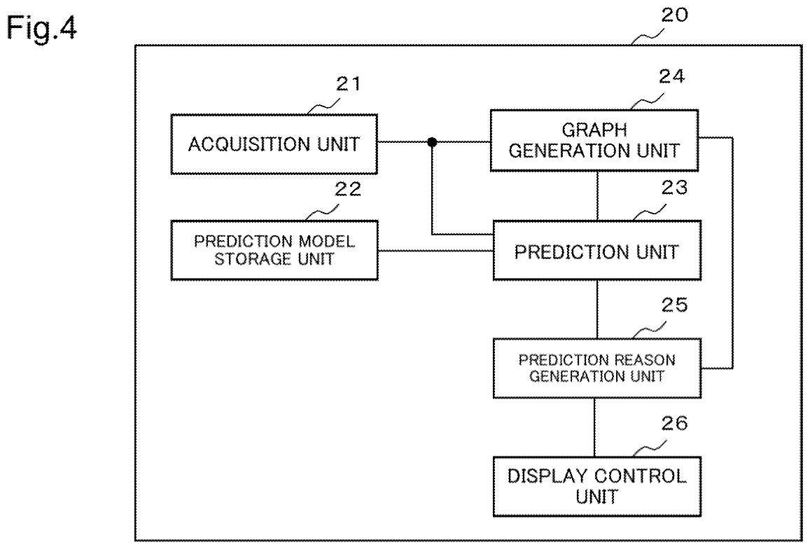

A configuration of the prediction device 20 will be described. FIG. 4 is a diagram illustrating a configuration of the prediction device 20. The prediction device 20 includes an acquisition unit 21, a prediction model storage unit 22, a prediction unit 23, a graph generation unit 24, a prediction reason generation unit 25, and a display control unit 26.

The acquisition unit 21 acquires input data when predicting customers (remarkable customers) who are likely to place orders and products that are likely to be ordered, using a prediction model. The acquisition unit 21 acquires, for example, data used for prediction from the sales data management server 300. The input data may be input to the prediction device 20 by an operator. The acquisition unit 21 acquires, as input data to be used for prediction of a customer who is likely to place an order, attribute data of a plurality of customers (target customers) as candidates for sales targets at a prediction time point, and data of an activity history of a sales activity that has been performed until the prediction time point as sales process time-series data.

The prediction model storage unit 22 stores a prediction model sent from the prediction model output unit 16 of the prediction model generation device 10.

The prediction unit 23 predicts a customer who is likely to place an order and a product that is likely to be ordered, and a sales process that is likely to receive an order, from the input data, based on a prediction model stored in the prediction model storage unit 22. The prediction unit 23 uses, as inputs, attribute data of a plurality of customers (target customers) and data of actions at an early stage of sales activities performed so far for each customer (time-series data of a sales process for the target customers), and predicts a customer who is likely to place an order, a product that is likely to be ordered, and a sales process that is likely to receive an order, using a prediction model.

The graph generation unit 24 generates a graph for a customer who is likely to place an order included in a prediction result of the prediction unit 23 based on the sales process, and outputs the graph as graph structure data to the prediction reason generation unit 25. The graph generation unit 24 generates a graph showing each action included in the sales process as a node and showing an order between the actions as an edge.

The prediction reason generation unit 25 extracts a reason for prediction of a combination of a customer who is likely to place an order, a product that are likely to be ordered, and a prediction result of the sales process.

The display control unit 26 controls a display unit (not illustrated) included in the prediction device 20 or a display device outside the prediction device 20 in such a way as to display the prediction result to which the prediction reason is added. The display control unit 26 may control the display on the display device by transmitting the prediction result to which the reason for the prediction is added to the terminal of the user who uses the prediction result, but the display control method is not limited to this.

The display control unit 26 generates display data for displaying a prediction result. The display control unit 26 generates display data for displaying a customer who is likely to place an order as a candidate for a remarkable customer to be recommended as a target of a sales activity and as a candidate for a remarkable customer to whom a product that is likely to be ordered is recommended as a sales target. The display control unit 26 generates display data with a plurality of customers ranked in descending order of the possibility of placing an order. The order of the order receiving possibility is calculated by the prediction unit 23 using the similarity between the input attribute data of the customer and the data of the activity history and the prediction model, and the past order reception results. The similarity is calculated when, for example, the prediction unit 23 predicts a product that is likely to be ordered and a remarkable customer using a prediction model generated with the STAR method. The display control unit 26 adds the reason for the prediction and the graph structure data that indicates the sales process that is likely to receive an order to the display data for displaying the prediction result of the prediction unit 23. The display control unit 26 controls display of the prediction result and the reason for the prediction on the display device. As a result, the invention of the present application can more suitably assist the sales activities by presenting the sales representative with customers who are likely to place orders and products that are likely to be ordered as well as the reason thereof.

Each processing in the acquisition unit 21, the prediction unit 23, the graph generation unit 24, the prediction reason generation unit 25, and the display control unit 26 is performed by a processor that executes a command executing a computer program. The processor may be a CPU, a GPU, or a combination of a CPU and a GPU.

The prediction model storage unit 22 is configured using, for example, a hard disk drive. The prediction model storage unit 22 may be configured with a nonvolatile semiconductor storage device or a combination of a plurality of types of storage devices.

In FIG. 1, the sales data management server 300 manages data of an activity history for each sales activity. As the data of the activity history, for example, data input by a sales representative via a terminal device is used. The activity history data may be data extracted from sales diaries. For example, the sales data management server 300 may extract, as the activity history data, “March 2”, which is date and time, “company X”, which is a target of the sales activity, and “e-mail” indicating an action in the sales activity from a sales daily record in which a sales representative wrote “Introduced the product A to the company by e-mail on March 2”. The sales data management server 300 transmits the data of the activity history to the prediction model generation device 10.

<Learning Phase>

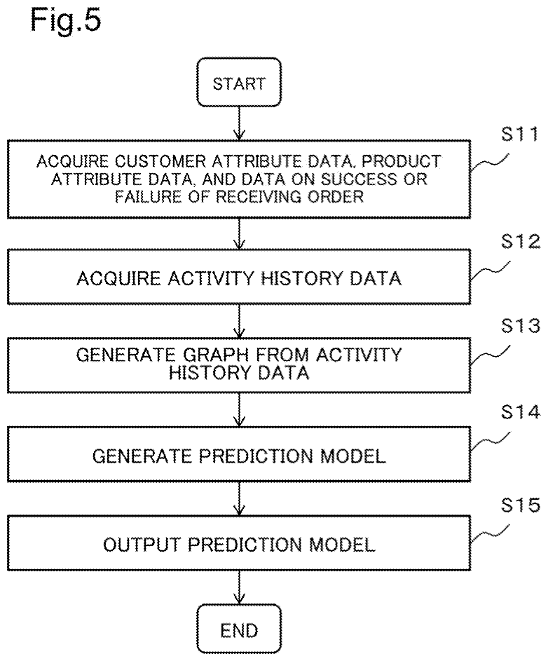

An operation of the sales assistance system of the present example embodiment will be described. First, an operation for generating a prediction model used for predicting a customer who is likely to place an order and a product that is likely to be ordered will be described. FIG. 5 is a diagram illustrating an operation flow when the prediction model generation device 10 generates a prediction model for predicting a customer who is likely to place an order and a product that is likely to be ordered.

The acquisition unit 11 acquires attribute data of a customer (existing customer) targeted in a plurality of sales activities performed in the past used as the attribute data, attribute data of a product to be sold, and data of success or failure of receiving an order for each sales activity (step S11). The data on success or failure of receiving an order includes information indicating whether an order has succeeded or failed for each sales activity. Each piece of data may be input by an operator or may be acquired from another server having each piece of data. The acquisition unit 11 may acquire, from the sales data management server 300, information indicating the results of the presence or absence of an order for each sales activity. When acquiring each piece of data, the acquisition unit 11 stores the acquired data in the storage unit 12.

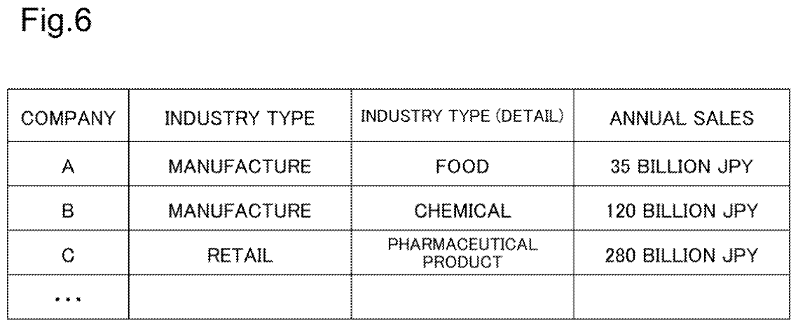

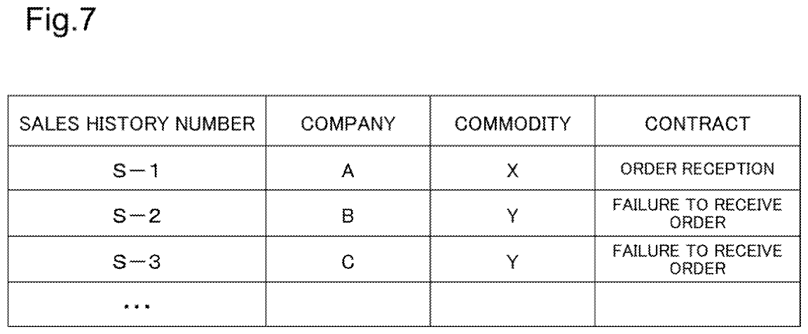

FIG. 6 is a diagram illustrating an example of information on customers (existing customers) used as attribute data. In the attribute data of the customers in FIG. 6, the company name, the industry type of the customer, the industry type (detail) obtained by further classifying the industry type, and annual sales are associated with each other. FIG. 7 is a diagram illustrating an example of data of success or failure of receiving an order used as labels. In the example of FIG. 7, the sales history number, which is identification information of an activity history, the company name of a customer, a commodity used for sales, and the result of success or failure of receiving an order are associated with each other.

The acquisition unit 11 acquires the sales process time-series data indicating the data of the activity history for each sales activity from the sales data management server 300 (step S12). When acquiring the sales process time-series data, the acquisition unit 11 stores the acquired data of the activity history in the storage unit 12.

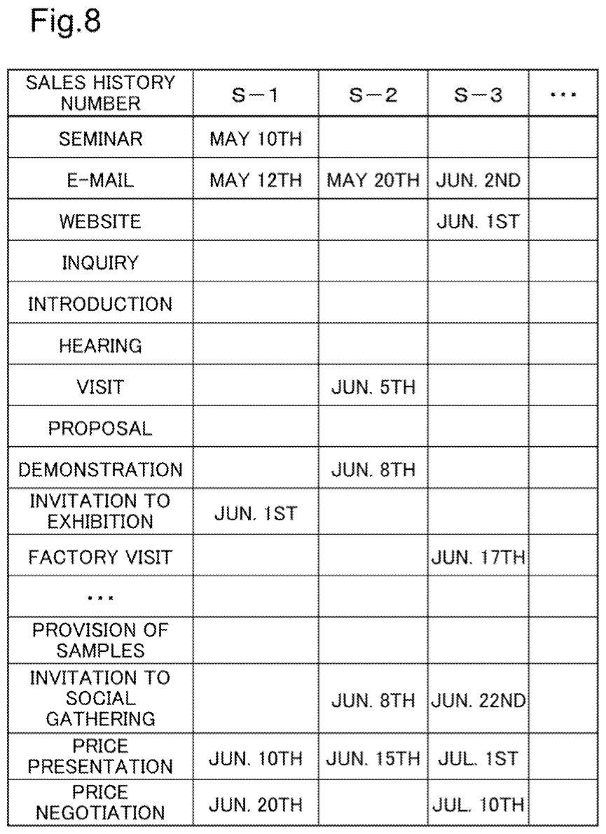

FIG. 8 is a diagram illustrating an example of the sales process time-series data. In the sales process time-series data of FIG. 8, the sales history number, which is identification information of an activity history, is associated with the date when each action is performed in the sales activity. The sales history number in FIG. 8 corresponds to the sales history number in FIG. 7.

When the sales process time-series data is stored in the storage unit 12, the graph generation unit 13 generates graph structure data based on the sales process time-series data (step S13). The graph generation unit 13 generates graph structure data in which actions executed in each sales process are arranged in time series with each action of the activity history as a node and with the order between the actions as an edge. After generating the graph structure data, the graph generation unit 13 sends the generated graph structure data to the prediction model generation unit 14.

When the graph structure data is input, the prediction model generation unit 14 reads each piece of data used for generation of a prediction model from the storage unit 12. When each piece of data is read, machine learning is performed using attribute data of each of a plurality of customers (existing customers), attribute data of a product, and graph structure data generated from an activity history as input data and using success or failure of receiving an order as a label, and a prediction model for predicting a customer who is likely to place an order and a product that is likely to be ordered is generated (step S14).

When the prediction model is generated, the prediction model generation unit 14 stores the generated prediction model in the prediction model storage unit 15 as a learned model. When the prediction model is stored, the prediction model output unit 16 outputs the prediction model to the prediction device 20 (step S15). The prediction model input to the prediction device 20 is stored in the prediction model storage unit 22.

The prediction model generated by the prediction model generation device 10 may be updated by relearning. For example, the prediction model generation unit 14 relearns a prediction model by machine learning in which the attribute data of the customer for whom the sales activity has been newly performed based on the prediction result, the attribute data of the product, and the data of the graph generated from the activity history are used as input data, and whether an order is received or not is used as a label. When relearning is performed, the prediction model generation unit 14 updates the prediction model stored in the prediction model storage unit 15. In this way, by performing relearning based on the prediction result, the prediction accuracy by the learned model is improved. The prediction model generation unit 14 may generate a new prediction model, based on the result, by machine learning in which the attribute data of the customer for whom the sales activity has been performed, the attribute data of the product, and the data of the graph generated from the activity history are used as input data and whether an order is received or not is used as a label.

<Prediction Phase>

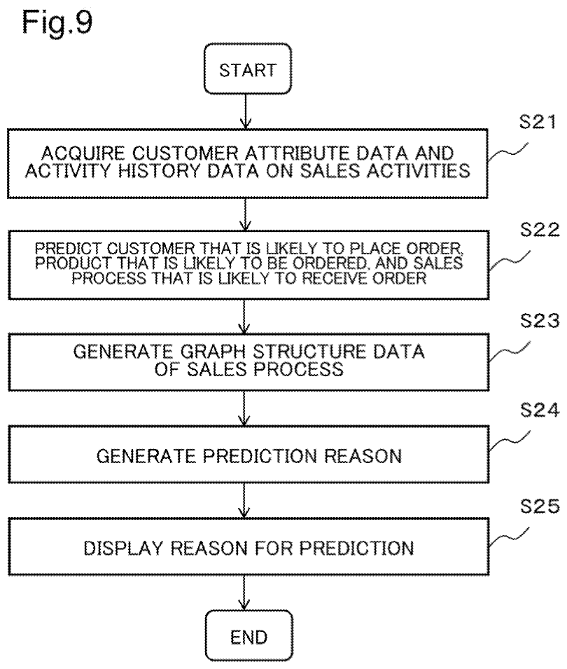

Next, an operation when predicting a customer who is likely to place an order and a product that is likely to be ordered in the prediction device 20 will be described. FIG. 9 is a diagram illustrating an operation flow when predicting a customer who is likely to place an order and a product that is likely to be ordered using a prediction model in the prediction device 20.

First, the acquisition unit 21 acquires, for a plurality of customers (target customers) to be predicted, attribute data of the customers and data of activity histories of the sales activities that have been performed until the prediction time point for each customer from the sales data management server 300 (step S21). Each piece of data may be input to the prediction device 20 by an operator. The data of the activity history of the sales activity that has been performed until the prediction time point for each customer is time-series data indicating the actions performed at an early stage of the sales activity and the order of the time-series in which the actions were performed.

The acquisition unit 21 may select a customer group from the customer groups hierarchized according to attributes and set the selected customer group as a prediction target. For example, it is assumed that a customer group is generated in which the attribute data is set as an industry type, the industry type is classified into, for example, a manufacturing industry and a wholesale industry in a higher hierarchy, and the manufacturing industry is further classified into, for example, food manufacturing and medicine manufacturing in a lower hierarchy. At this time, for example, the acquisition unit 21 may set all the customer groups included in the manufacturing industry to be selectable depending on the input by an operator or the like, or may set only customer groups included in food manufacturing of the lower hierarchy to be selectable.

When the acquisition unit 21 acquires the data of the activity history, the prediction unit 23 uses a prediction model stored in the prediction model storage unit 22 to predict a customer (remarkable customer) who is likely to place an order, a product (recommended product) that is likely to be ordered, and a sales process that is likely to receive an order, using as inputs the attribute data of the customers (target customers) and the data of the activity histories (sales process time-series data) (step S22). After predicting the customer who is likely to place an order, the product that is likely to be ordered, and the sales process that is likely to receive an order, the prediction unit 23 transmits as prediction results the data of the customer who is likely to place an order and the product that is likely to be ordered and the data of the sales process that is likely to receive an order to the graph generation unit 24. The prediction result includes the information of attribute data having a high degree of contribution to the prediction when the customer who is likely to place an order and the product that is likely to be ordered are predicted using a prediction model.

Upon receiving the prediction result, the graph generation unit 24 generates graph structure data to be used for displaying the prediction result, from the sales process that is likely to receive an order included in the prediction result (step S23). The graph generation unit 24 generates graph structure data showing an action included in a sales process that is likely to receive an order as a node and showing an order between the actions as an edge.

When the graph structure data is generated, the graph generation unit 24 adds the graph structure data to the prediction result and sends the prediction result to the prediction reason generation unit 25.

Upon receiving the prediction result, the prediction reason generation unit 25 generates a prediction reason (step S24). The prediction reason generation unit 25 extracts, for example, the attribute data having a high degree of contribution to success of receiving an order as a prediction reason, from the data of the prediction result. When the attribute data having a high degree of contribution to the prediction is the industry type, the prediction reason generation unit 25 generates, for example, the information indicating that there is a purchase record in another company of the same industry type as the prediction reason.

When the prediction reason is extracted, the prediction reason generation unit 25 further adds the prediction reason to the prediction result and outputs the prediction result to the display control unit 26.

Upon receiving the prediction result, the display control unit 26 generates display data for displaying the prediction result. After generating the display data, the display control unit 26 controls the display device to display the prediction result on the display device (step S25). The display control unit 26 may control transmission of the data of the prediction result to a terminal of a user who uses the prediction result in such a way that the prediction result is displayed on the display device of the terminal of the user.

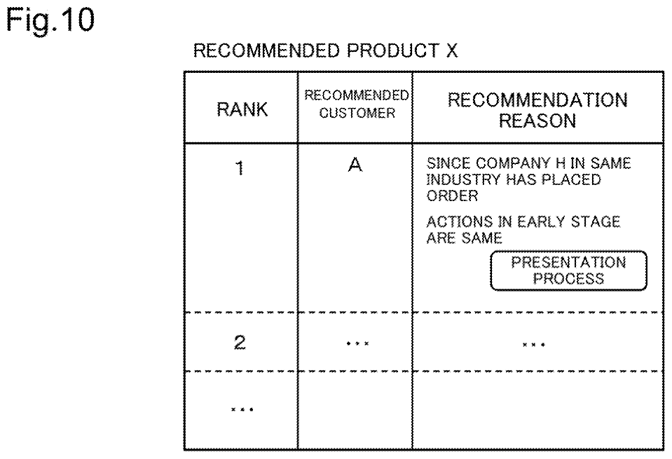

FIG. 10 is a diagram illustrating an example of display data of a prediction result. The display data of the prediction result of FIG. 10 illustrates that a product X is a product that is likely to be ordered and illustrates an example of the display data displayed as the recommended product X. The display data of the prediction result in FIG. 10 is configured with a rank indicating the possibility of receiving an order, a recommended customer name, and a recommended reason indicating a prediction reason. The recommended customer name indicates a name of a customer to be recommended as a target of a sales activity and as a remarkable customer who is likely to place an order. FIG. 10 illustrates that the company A is likely to place an order, and as a reason, the company H in the same industry has placed an order and actions in an early stage of sales activities are the same. As illustrated in FIG. 10, with indication of a plurality of customer candidates as a prediction result and a reason when it is predicted that the possibility of receiving an order is high, the user of the prediction result can select a customer to whom sales are intensively conducted for obtaining an order with reference to the prediction reason.

When generating a reason for prediction, the prediction reason generation unit 25 holds in advance, for example, the information of names of representative customers having placed orders for each combination of attribute data and product. When generating a reason for prediction, the prediction reason generation unit 25 extracts a customer corresponding to a combination of attribute data having a high degree of contribution to the prediction result and a recommended product from the held information, and extracts that the extracted customer has placed an order as a reason for prediction. As a representative customer who placed orders in the past, for example, among customers who placed orders for each attribute data, a customer having a large management scale and high name recognition or a customer having a larger number of placing orders than other companies is set.

The prediction reason generation unit 25 may generate a reason for prediction based on a predefined template. The prediction reason generation unit 25 generates a prediction reason “because there is an order record in company A in the same industry” when, for example, a template “because there is an order record in company XX in the same industry” is held and “company A” is a representative company of companies that placed orders.

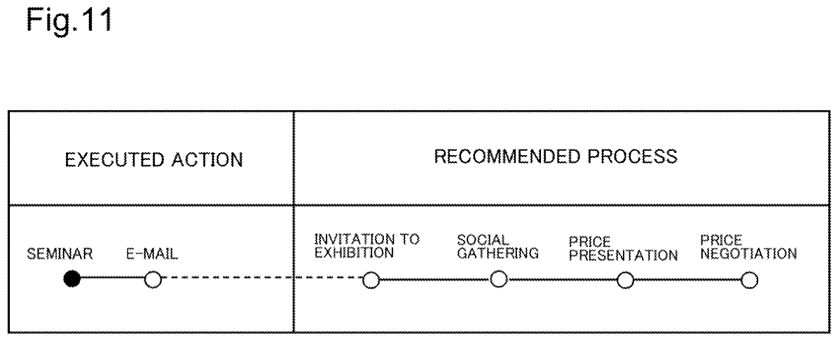

FIG. 10 illustrates an example in which the button for displaying a sales process that is likely to receive an order is set as “presentation process” in the recommended reason column. FIG. 11 illustrates an example of a sales process that is likely to receive an order, which is displayed when the “presentation process” button is pressed. In the example of FIG. 11, a seminar and an e-mail are shown as executed actions, and the sales process that is likely to receive an order is shown as a recommended process.

The recommended process as illustrated in FIG. 11 may be set to be displayed when the cursor is placed on the “presentation process” button on the display screen of FIG. 10. In FIG. 10, the recommended process illustrated in FIG. 11 may be displayed when a mouse click or a tap is performed on the “presentation process” portion on the display screen.

In the above description, the edge of the graph structure data used for generating the prediction model indicates only the order of the actions, but the length of time between the actions may be included in the edge. By performing prediction with the prediction model generated using the graph structure data including the information on the length of time between actions in the edge, it is possible to predict appropriate timing at which each action is performed. When the prediction result is displayed as illustrated in FIG. 11, the time interval indicated by the edge may be displayed by placing the cursor on the edge on the display screen. When the edge portion is clicked or tapped on the display screen, the time interval indicated by the edge may be displayed.

The industry type, the industry type (details), and the annual sales are used as the attribute data of the customer, but the attribute data of the customer may include at least one item among the industry type, capital stock, the number of employees, the sales, the profit, the material purchase amount, the number of branches, the number of factories, the sales form, the transaction record, or other indexes indicating characteristics of the company of the customer. As the industry type, for example, hierarchical data such as a large classification, a middle classification, and a small classification prescribed in JIS (Japanese Industrial Standards) may be used.

The customer may be an individual. In a case where the customer is an individual, the attribute data of the customer may include at least one item of age, sex, revenue, place of employment, number of people in family, place of residence, transaction record, status of subscription to a membership system, and whether a mail magazine is subscribed or not. In addition to the attribute data or the like of the customer, at least one item of a classification of products or services to be sold, products or services to be sold, sales of a customer to be subjected to a sales activity, a sales representative, a position of the sales representative, or a class of the sales representative may be used as input data when a prediction model is generated. When the attribute data of a customer, who is a target of these sales activities, or a sales representative is used for generating a prediction model, the attribute data can be also used for input at a prediction stage.

For the attribute data when the prediction model is generated and predicted, instead of the attribute data of the customer, information of one or more attributes of a company, who is a target of the sales activities, or a sales representative, such as a classification of products or a services to be sold, products or services to be sold, sales of a customer to be subjected to a sales activity, a sales representative, a position of the sales representative, or a class of the sales representative may be used as input data. The above attribute data may be used in addition to the attribute data of the customer. When the attribute data of a customer, who is a target of these sales activities, or a sales representative is used for generating a prediction model, the attribute data can be also used for input at a prediction stage.

The reasons for the prediction may include any one or a plurality of items of sales, annual profit, the number of employees, purchase records, a classification of products or services to be sold, products or services to be sold, sales of customers to be subjected to a sales activity, a sales representative, and a position of a sales representative, in addition to the fact that there is an order reception record in customers whose industry type matches that of the remarkable customer. The reasons for these predictions may be used together with the reason that there is an order reception record in the customers whose industry type matches that of the remarkable customer.

In the sales assistance system of the present example embodiment, the prediction model generation device 10 generates a prediction model by machine learning using, as inputs, attribute data of a plurality of customers, graph structure data generated based on data of an activity history of a sales activity for each customer, and attribute data of a product. In the sales assistance system of the present example embodiment, the prediction device 20 predicts a customer who is likely to place an order, a product that is likely to be ordered, and a sales process that is likely to receive an order, from attribute data of each customer and an action of a sales activity performed on each customer based on the generated prediction model. The sales assistance system of the present example embodiment can predict a customer who is likely to place an order from among customers to which actions of sales activities are directed, and a product that is likely to be ordered, and predict a recommended sales process at or after the current time point. As a result, the sales assistance system of the present example embodiment can present, as a prediction result, a customer who is likely to place an order, a product that is likely to be ordered, and a sales process that is likely to receive an order, thereby presenting the information for performing efficient sales activities without depending on the skill of a sales representative or the like. Therefore, the sales assistance system of the present example embodiment can predict a customer who is likely to place an order among customers to which sales activities are directed, and a product that is likely to be ordered, thereby assisting the sales activities such as increasing a success probability of receiving an order and improving efficiency of the sales activities.

### Second Example Embodiment

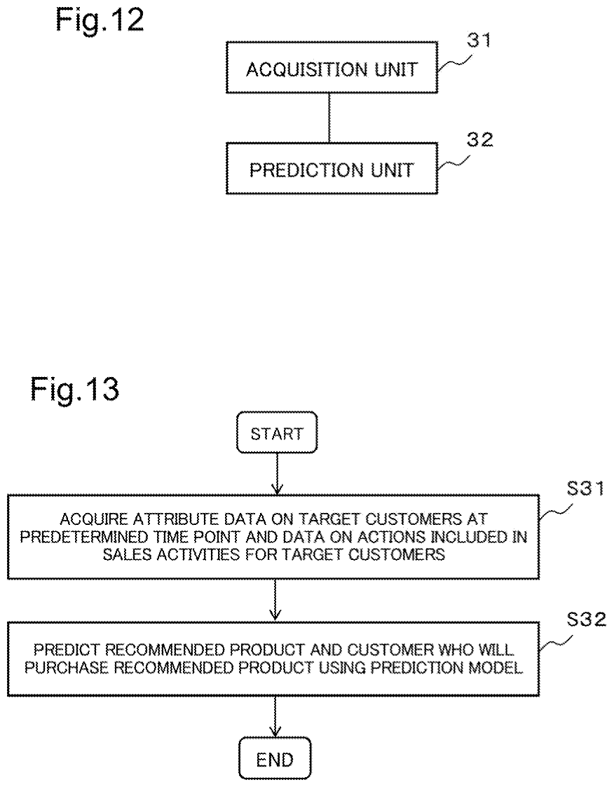

A second example embodiment of the present invention will be described in detail with reference to the drawings. FIG. 12 is a diagram illustrating an outline of a configuration of a sales assistance system of the present example embodiment. The sales assistance system of the present example embodiment includes an acquisition unit 31 and a prediction unit 32. In the sales assistance system of the present example embodiment, the acquisition unit 31 and the prediction unit 32 may be provided in a single device, or may be provided in different devices.

The acquisition unit 31 acquires attribute data on a plurality of target customers as candidates for sales targets, and sales process time-series data on time series of actions included in sales activities that have been directed to each of the plurality of target customers until a predetermined time point. The acquisition unit 31 is an example of an acquisition means. An example of the acquisition unit 31 is the acquisition unit 21 of the prediction device 20 of the first example embodiment.

The prediction unit 32 uses a prediction model and the attribute data on the plurality of target customers and the sales process time-series data acquired by the acquisition unit 31, and predicts recommended products for the plurality of target customers, and customers who are likely to purchase the recommended products among the plurality of target customers. The prediction model is generated based on the attribute data on each of a plurality of existing customers in previous sales records before a predetermined time point, the sales process time-series data, and the product data on products purchased by the plurality of existing customers through the sales activities. The sales process time-series data indicates a time-series order of a plurality of actions included in sales activities for the plurality of existing customers. The prediction unit 32 is an example of a prediction means. An example of the prediction unit 32 is the prediction unit 23 of the prediction device 20 of the first example embodiment.

An operation of the sales assistance system of the present example embodiment will be described. FIG. 13 is a diagram illustrating an operation flow of the sales assistance system of the present example embodiment. First, the acquisition unit 31 acquires attribute data on each of a plurality of target customers as candidates for sales targets, and sales process time-series data on time series of actions included in sales activities that have been directed to each of the plurality of target customers until a predetermined time point (step S31). When the attribute data of each of the target customers who are candidates for the sales target and the sales process time-series data are acquired, the prediction unit 32 predicts the recommended product and the customer who will purchase the recommended product from the attribute data of each of the target customers and the sales process time series-data, using the prediction model (step S32).

The sales assistance system of the present example embodiment inputs, to the prediction model, the action for the target customer until a predetermined time point, which is a prediction time point, and the attribute data of the target customer, thereby predicting a recommended product that is likely to be ordered and a customer who is likely to purchase the recommended product. Since the sales assistance system of the present example embodiment performs prediction using the action of sales activities until the prediction time point, the prediction can be performed in consideration of activities until the prediction time point. Therefore, the sales assistance system of the present example embodiment can predict a customer who is likely to place an order among customers to which actions in an early stage of sales activities are directed, and a product that is likely to be ordered.

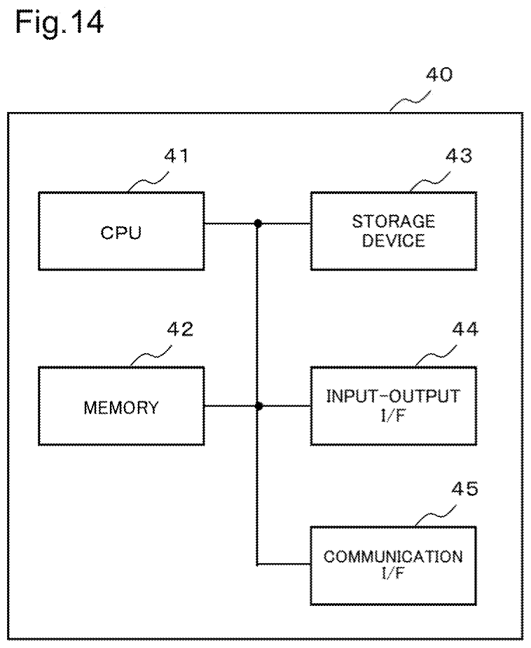

Each processing in the prediction model generation device 10 and the prediction device 20 of the first example embodiment can be performed by executing a computer program on a computer. FIG. 14 illustrates an example of a configuration of a computer 40 that executes a computer program for performing each processing in the prediction model generation device 10 and the prediction device 20. The computer 40 includes a CPU 41, a memory 42, a storage device 43, an input/output I/F (interface) 44, and a communication I/F 45. Each processing in the sales data management server 300 of the first example embodiment and the sales assistance system of the second example embodiment can also be performed by executing a computer program on the computer 40 having a similar configuration.

The CPU 41 reads and executes a computer program for performing each processing from the storage device 43. An arithmetic processing unit that executes the computer program may be configured by a combination of a CPU and a GPU instead of the CPU 41. The memory 42 includes a dynamic random access memory (DRAM) or the like, and temporarily stores a computer program executed by the CPU 41 and data being processed. The storage device 43 stores a computer program executed by the CPU 41. The storage device 43 includes, for example, a nonvolatile semiconductor storage device. As the storage device 43, another storage device such as a hard disk drive may be used. The input/output I/F 44 is an interface that receives an input from an operator and outputs display data and the like. The communication I/F 45 is an interface that transmits and receives data to and from each device in the sales assistance system, a terminal of a user, and the like.

The computer program used for execution of each processing by the CPU 41 can also be stored in a recording medium to be distributed. As the recording medium, for example, a magnetic tape for data recording or a magnetic disk such as a hard disk can be used. As a recording medium, an optical disk such as a compact disc read only memory (CD-ROM) can also be used. A non-volatile semiconductor storage device may be used as a recording medium.

Some or all of the above example embodiments may be described as the following supplementary notes, but are not limited to the to them.

### [Supplementary Note 1]

A sales assistance system including:
an acquisition means configured to acquire attribute data on each of a plurality of target customers as candidates for sales targets, and sales process time-series data on time series of actions included in sales activities that have been directed to each of the plurality of target customers until a predetermined time point; and
a prediction means configured to predict a recommended product for the plurality of target customers and a customer who will purchase the recommended product among the plurality of target customers by using a prediction model generated based on attribute data of each of a plurality of existing customers having sales records before the predetermined time point, sales process time-series data indicating a time-series order of a plurality of actions included in sales activities for the plurality of existing customers, and product data on products purchased by the plurality of existing customers through the sales activities, and the attribute data of the plurality of target customers and the sales process time-series data acquired by the acquisition means.

### [Supplementary Note 2]

The sales assistance system according to supplementary note 1, further including:
a display control means configured to control a display device to display a prediction result by the prediction means and a reason for the prediction.

### [Supplementary Note 3]

The sales assistance system according to supplementary note 2, in which
the display control means controls the display device to display the plurality of target customers in order of priority of a sales activity based on the attribute data of each of the plurality of existing customers and the attribute data of each of the plurality of target customers.

### [Supplementary Note 4]

The sales assistance system according to supplementary note 3, in which
the prediction means calculates a customer similarity indicating a similarity in attributes and sales activities between each of the plurality of existing customers and each of the plurality of target customers based on attribute data of each of the plurality of existing customers, attribute data of each of the plurality of target customers, sales process time-series data indicating a time-series order of a plurality of actions included in the sales activities for each of the plurality of existing customers, and sales process time-series data on time series of actions included in the sales activities that have been directed to each of the plurality of target customers, and
the display control means controls the display device to display the plurality of target customers in order of priority of sales activities based on the customer similarity.

### [Supplementary Note 5]

The sales assistance system according to any one of supplementary notes 2 to 4, in which
the display control means controls the display device to display a sales process at or after the predetermined time point for a customer who is predicted to purchase the recommended product by the prediction means.

### [Supplementary Note 6]

The sales assistance system according to supplementary note 5, in which
the display control means displays the recommended sales process as a graph structure including nodes corresponding to a plurality of actions included in the sales process and edges indicating an order between the actions.

### [Supplementary Note 7]

The sales assistance system according to any one of supplementary notes 1 to 6, in which
the attribute data of the customer includes at least one of an industry type, the number of employees, capital, sales, profit, a material purchase amount, the number of branches, the number of factories, a sales form, and a transaction record of the customer.

### [Supplementary Note 8]

The sales assistance system according to any one of supplementary notes 1 to 7, in which
attribute data of the product includes at least one of product type, period during which the product is sold, sales record, the number of trading companies, variation, presence or absence of an advertisement, production country, and form of provision.

### [Supplementary Note 9]

The sales assistance system according to any one of supplementary notes 1 to 8,
further including a prediction model generation means configured to generate the prediction model by performing machine learning using, as inputs, attribute data of each of a plurality of existing customers having sales records before the predetermined time point, sales process time-series data indicating a time-series order of a plurality of actions included in sales activities for the plurality of existing customers, and product data on products purchased by the plurality of existing customers through the sales activities.

### [Supplementary Note 10]

The sales assistance system according to supplementary note 9, in which
the prediction model generation means relearns the prediction model based on attribute data of each customer of the sales activities executed in accordance with a prediction result by the prediction means, sales process time-series data indicating a time-series order of a plurality of actions performed for each customer, and product data on a product purchased by the customer through the sales activities.

### [Supplementary Note 11]

A sales assistance method including:
acquiring attribute data on each of a plurality of target customers as candidates for sales targets, and sales process time-series data on time series of actions included in sales activities that have been directed to each of the plurality of target customers until a predetermined time point; and
predicting a recommended product for the plurality of target customers and a customer who will purchase the recommended product among the plurality of target customers by using a prediction model generated based on attribute data of each of a plurality of existing customers having sales records before the predetermined time point, sales process time-series data indicating a time-series order of a plurality of actions included in sales activities for the plurality of existing customers, and product data on products purchased by the plurality of existing customers through the sales activities, and the attribute data of the plurality of target customers and the sales process time-series data acquired.

### [Supplementary Note 12]

The sales assistance method according to supplementary note 11, further including
controlling the display device to display a prediction result and a reason for the prediction.

### [Supplementary Note 13]

The sales assistance method according to supplementary note 12, further including
controlling the display device to display the plurality of target customers in order of priority of a sales activity based on attribute data of each of the plurality of existing customers and attribute data of each of the plurality of target customers.

### [Supplementary Note 14]

The sales assistance method according to supplementary note 13, further including:
calculating a customer similarity indicating a similarity in attributes and sales activities between each of the plurality of existing customers and each of the plurality of target customers based on attribute data of each of the plurality of existing customers, attribute data of each of the plurality of target customers, sales process time-series data indicating a time-series order of a plurality of actions included in sales activities for the plurality of existing customers, and sales process time-series data on time series of actions included in sales activities that have been directed to each of the plurality of target customers; and
controlling the display device to display the plurality of target customers in order of priority of sales activities based on the customer similarity.

### [Supplementary Note 15]

The sales assistance method according to any one of supplementary notes 12 to 14, further including
controlling the display device to display a sales process at or after the predetermined time point for a customer who is predicted to purchase the recommended product.

### [Supplementary Note 16]

The sales assistance method according to supplementary note 15, further including
displaying the recommended sales process as a graph structure including a node corresponding to each of a plurality of actions included in the sales process and an edge indicating an order between the actions.

### [Supplementary Note 17]

The sales assistance method according to any one of supplementary notes 11 to 16, in which
the attribute data of the customer includes at least one of an industry type, the number of employees, capital, sales, profit, a material purchase amount, the number of branches, the number of factories, a sales form, and a transaction record of the customer.

### [Supplementary Note 18]

The sales assistance method according to any one of supplementary notes 11 to 17, in which
attribute data of the product includes at least one of product type, period during which the product is sold, sales record, the number of trading companies, variation, presence or absence of an advertisement, production country, and form of provision.

### [Supplementary Note 19]

The sales assistance method according to any one of supplementary notes 11 to 18, further including
generating the prediction model by performing machine learning using, as inputs, attribute data of each of a plurality of existing customers having sales records before the predetermined time point, sales process time-series data indicating a time-series order of a plurality of actions included in sales activities for the plurality of existing customers, and product data on products purchased by the plurality of existing customers through the sales activities.

### [Supplementary Note 20]

The sales assistance method according to supplementary note 19, further including
relearning the prediction model based on attribute data of each customer of the sales activities executed in accordance with a prediction result, sales process time-series data indicating a time-series order of a plurality of actions performed for each customer, and product data on a product purchased by the customer through the sales activities.

### [Supplementary Note 21]

A program recording medium recording a sales assistance program that makes a computer execute processing of:
acquiring attribute data on each of a plurality of target customers as candidates for sales targets, and sales process time-series data on time series of actions included in sales activities that have been directed to each of the plurality of target customers until a predetermined time point; and
predicting a recommended product for the plurality of target customers and a customer who will purchase the recommended product among the plurality of target customers by using a prediction model generated based on attribute data of each of a plurality of existing customers having sales records before the predetermined time point, sales process time-series data indicating a time-series order of a plurality of actions included in sales activities for the plurality of existing customers, and product data on products purchased by the plurality of existing customers through the sales activities, and the attribute data of the plurality of target customers and the sales process time-series data acquired.

### [Supplementary Note 22]

A sales assistance device including:
an acquisition means configured to acquire attribute data on each of a plurality of target customers as candidates for sales targets, and sales process time-series data on time series of actions included in sales activities that have been directed to each of the plurality of target customers until a predetermined time point; and
a prediction means configured to predict a recommended product for the plurality of target customers and a customer who will purchase the recommended product among the plurality of target customers by using a prediction model generated based on attribute data of each of a plurality of existing customers having sales records before the predetermined time point, sales process time-series data indicating a time-series order of a plurality of actions included in sales activities for the plurality of existing customers, and product data on products purchased by the plurality of existing customers through the sales activities, and the attribute data of the plurality of target customers and the sales process time-series data acquired by the acquisition means.

The present invention has been described above using the above-described example embodiments as exemplary examples. However, the present invention is not limited to the above-described example embodiments. That is, the present invention can be applied to various aspects that can be understood by those skilled in the art within the scope of the present invention.

### REFERENCE SIGNS LIST

10 Prediction model generation device
11 Acquisition unit
12 Storage unit
13 Graph generation unit
14 Prediction model generation unit
15 Prediction model storage unit
16 Prediction model output unit
20 Prediction device
21 Acquisition unit
22 Prediction model storage unit
23 Prediction unit
24 Graph generation unit
25 Prediction reason generation unit
26 Display control unit
31 Acquisition unit
32 Prediction unit
40 Computer
41 CPU
42 Memory
43 Storage device
44 Input/output I/F
45 Communication I/F
100 Prediction system
300 Sales data management server

What is claimed is:

1. A sales assistance system comprising:
at least one memory storing instructions; and
at least one processor configured to access the at least one memory and execute the instructions to:
attribute data on each of a plurality of target customers as candidates for sales targets, and sales process time-series data on time series of actions included in sales activities that have been directed to each of the plurality of target customers until a predetermined time point; and
predict a recommended product for the plurality of target customers and a customer who will purchase the recommended product among the plurality of target customers based on the attribute data of the plurality of target customers and the sales process time-series data by using a prediction model, wherein
the prediction model is generated based on attribute data of each of a plurality of existing customers having sales records before the predetermined time point, sales process time-series data indicating a time-series order of a plurality of actions included in sales activities for the plurality of existing customers, and product data on products purchased by the plurality of existing customers through the sales activities.

2. The sales assistance system according to claim 1, wherein
the at least one processor is further configured to execute the instructions to:
display a prediction result and a reason for the prediction.

3. The sales assistance system according to claim 2, wherein
the at least one processor is further configured to execute the instructions to:
display the plurality of target customers in order of priority of a sales activity based on the attribute data of each of the plurality of existing customers and the attribute data of each of the plurality of target customers.

4. The sales assistance system according to claim 3, wherein
the at least one processor is further configured to execute the instructions to:
calculate a customer similarity indicating a similarity in attributes and sales activities between each of the plurality of existing customers and each of the plurality of target customers based on attribute data of each of the plurality of existing customers, attribute data of each of the plurality of target customers, sales process time-series data indicating a time-series order of a plurality of actions included in the sales activities for each of the plurality of existing customers, and sales process time-series data on time series of actions included in the sales activities that have been directed to each of the plurality of target customers; and
display the plurality of target customers in order of priority of sales activities based on the customer similarity.

5. The sales assistance system according to claim 2, wherein
the at least one processor is further configured to execute the instructions to:
display a sales process at or after the predetermined time point for a customer who is predicted to purchase the recommended product.

6. The sales assistance system according to claim 5, wherein
the at least one processor is further configured to execute the instructions to:
display the recommended sales process as a graph structure including nodes corresponding to a plurality of actions included in the sales process and edges indicating an order between the actions.

7. The sales assistance system according to claim 1, wherein
the attribute data of the customer includes at least one of an industry type, the number of employees, capital, sales, profit, a material purchase amount, the number of branches, the number of factories, a sales form, and a transaction record of the customer.

8. The sales assistance system according to claim 1, wherein
attribute data of the product includes at least one of product type, period during which the product is sold, sales record, the number of trading companies, variation, presence or absence of an advertisement, production country, and form of provision.

9. The sales assistance system according to claim 1, wherein
the at least one processor is further configured to execute the instructions to:
generate the prediction model by performing machine learning using, as inputs, attribute data of each of a plurality of existing customers having sales records before the predetermined time point, sales process time-series data indicating a time-series order of a plurality of actions included in sales activities for the plurality of existing customers, and product data on products purchased by the plurality of existing customers through the sales activities.

10. The sales assistance system according to claim 9, wherein
the at least one processor is further configured to execute the instructions to:
relearn the prediction model based on attribute data of each customer of the sales activities executed in accordance with a prediction result by the prediction means, sales process time-series data indicating a time-series order of a plurality of actions performed for each customer, and product data on a product purchased by the customer through the sales activities.

11. A sales assistance method comprising:
acquiring attribute data on each of a plurality of target customers as candidates for sales targets, and sales process time-series data on time series of actions included in sales activities that have been directed to each of the plurality of target customers until a predetermined time point; and
predicting a recommended product for the plurality of target customers and a customer who will purchase the recommended product among the plurality of target customers based on the attribute data of the plurality of target customers and the sales process time-series data by using a prediction model, wherein
the prediction model is generated based on attribute data of each of a plurality of existing customers having sales records before the predetermined time point, sales process time-series data indicating a time-series order of a plurality of actions included in sales activities for the plurality of existing customers, and product data on products purchased by the plurality of existing customers through the sales activities.

12. The sales assistance method according to claim 11, further comprising
displaying a prediction result and a reason for the prediction.

13. The sales assistance method according to claim 12, further comprising
displaying the plurality of target customers in order of priority of a sales activity based on attribute data of each of the plurality of existing customers and attribute data of each of the plurality of target customers.

14. The sales assistance method according to claim 13, further comprising:
calculating a customer similarity indicating a similarity in attributes and sales activities between each of the plurality of existing customers and each of the plurality of target customers based on attribute data of each of the plurality of existing customers, attribute data of each of the plurality of target customers, sales process time-series data indicating a time-series order of a plurality of actions included in sales activities for the plurality of existing customers, and sales process time-series data on time series of actions included in the sales activities that have been directed to each of the plurality of target customers; and
displaying the plurality of target customers in order of priority of sales activities based on the customer similarity.

15. The sales assistance method according to claim 12, further comprising
displaying a sales process at or after the predetermined time point for a customer who is predicted to purchase the recommended product.

16. The sales assistance method according to claim 15, further comprising
displaying the recommended sales process as a graph structure including a node corresponding to each of a plurality of actions included in the sales process and an edge indicating an order between the actions.

17. The sales assistance method according to claim 11, wherein
the attribute data of the customer includes at least one of an industry type, the number of employees, capital, sales, profit, a material purchase amount, the number of branches, the number of factories, a sales form, and a transaction record of the customer.

18. The sales assistance method according to claim 11, wherein
attribute data of the product includes at least one of product type, period during which the product is sold, sales record, the number of trading companies, variation, presence or absence of an advertisement, production country, and form of provision.

19. The sales assistance method according to claim 11, further comprising
generating the prediction model by performing machine learning using, as inputs, attribute data of each of a plurality of existing customers having sales records before the predetermined time point, sales process time-series data indicating a time-series order of a plurality of actions included in sales activities for the plurality of existing customers, and product data on products purchased by the plurality of existing customers through the sales activities.

20. (canceled)

21. A non-transitory program recording medium recording a sales assistance program that makes a computer execute processing of:
acquiring attribute data on each of a plurality of target customers as candidates for sales targets, and sales process time-series data on time series of actions included in sales activities that have been directed to each of the plurality of target customers until a predetermined time point; and
predicting a recommended product for the plurality of target customers and a customer who will purchase the recommended product among the plurality of target customers based on the attribute data of the plurality of target customers and the sales process time-series data by using a prediction model, wherein
the prediction model is generated based on attribute data of each of a plurality of existing customers having sales records before the predetermined time point, sales process time-series data indicating a time-series order of a plurality of actions included in sales activities for the plurality of existing customers, and product data on products purchased by the plurality of existing customers through the sales activities.
